(19) United States
(12) Patent Application Publication
(10) Pub. No.: US 2020/0117581 A1
(43) Pub. Date: Apr. 16, 2020

(54) CONFIGURATION FILE UPDATING SYSTEM FOR USE WITH CLOUD SOLUTIONS

(71) Applicant: Bank of America Corporation, Charlotte, NC (US)

(72) Inventors: Navin Rajapakse, Hoboken, NJ (US); Anthony D. Zuress, Charlotte, NC (US); Jobin Thomas, Charlotte, NC (US); Girish Nagasamudra, Frisco, TX (US)

(21) Appl. No.: 16/157,188

(22) Filed: Oct. 11, 2018

(51) Int. Cl. G06F 11/36

(52) U.S. Cl. CPC G06F 11/3688; G06F 11/3692; G06F 11/3664

(57) ABSTRACT

A hybrid cloud computing and local computing system is provided. The system may include a cloud computing environment and a local computing environment. The system may include a source control repository, a development repository, a production repository, a developer experience development repository and/or a disposable development and testing environment. The disposable environment may include a plurality of configuration files and an export function. The system may activate the export function to export the plurality of configuration files to the local computing environment. The system may store the configuration files within the local computing environment. The system may receive, at the local computing environment, modifications to the configuration files and transmit the modifications to the source control repository. The system may perform a comparison between the modifications and a set of source control configuration files and update the set of source control configuration files with the modifications.

### FIELD OF TECHNOLOGY

This disclosure relates to updating systems for use with cloud solutions. Specifically, this disclosure relates to hybrid solutions that enable, using cloud computing, configuration file updating.

### BACKGROUND OF THE DISCLOSURE

Typical non-cloud-based software is written in a software programming language on a software framework. Such frameworks include the Java® framework by Oracle® and the .NET TM framework by Microsoft®.

Software code is conventionally written in a text file. Conventional programs require source code text files as well as eXtensible Markup Language (“XML”) data, property settings and/or other artifacts that are required for the source code to function.

A source code text file, and the artifacts that support the source code text file, are usually compiled into an executable file. The executable file is then installed on a computer or server. The computer and/or server executes the executable file.

Software development—i.e., the creation of software code—using cloud-based technology differs from software development using non-cloud-based technology. Cloud-based software code, and all associated artifacts, actually reside in the cloud. The software is written in the cloud, compiled in the cloud, executed in the cloud and deployed from the cloud. Therefore, with a cloud-based software application, a source code text file is typically not readily available. This is opposed to a non-cloud-based software application, such as a JAVA application or .NET application, with which a source code text file is readily available. In a cloud-based software application, in order to update or fix software resident on a cloud, a developer is required to actually access the executable within the cloud.

There are a number of problems associated with cloud-based software development. Firstly, because the software code is being updated directly on the executable within the cloud, identifiers that match developers with their respective code contributions are unavailable. Thus, in a cloud computing environment, an inability to identify which developer wrote which code element exists.

Secondly, because updates are being made directly to the executable, all updates from all developers must be completed in order for code to move from a first cloud environment to a second cloud environment. This means when two developers are working on a single project, and a first developer completes a first portion of the project, and a second developer has not yet completed a second portion of the project, the portion completed by the first developer cannot be promoted from a cloud development environment to a cloud testing environment because the first portion and the second portion are inseparable. In other words, in a cloud computing environment, there is an inability to selectively merge, build and promote code elements.

Third, for a single cloud-based software application, there may be multiple software pipelines being developed. A first pipeline of an application may be scheduled to go to production after a week. A second pipeline of the application may be scheduled to go to production after a month. A third pipeline of the application may be scheduled to go to production after a year. If a developer writes a software update for the application in the first pipeline, the developer is required to manually update all of the remaining pipelines with the software update. In a cloud computing environment, there is an inability to update all pipelines with a single update function.

Therefore, there exists a need for a hybrid system that utilizes non-cloud software development techniques within a cloud-based software environment. It would be desirable for the hybrid system to enable developer identification for code elements. It would be further desirable for the hybrid system to enable selective merging, building and promotion of code elements. It would be yet further desirable for the hybrid system to update all software pipelines with a single update function.

### SUMMARY OF THE DISCLOSURE

Aspects of the disclosure relate to merging a cloud computing system and a local computing system. The method may include creating a disposable development and testing environment within the cloud computing system. The disposable development and testing environment may include one or more configuration files or a plurality of configuration files. The file type of the configuration files may be a comma separated value (“CSV”) file type or any other suitable file type. The disposable development and testing environment may include one or more metadata files. The file type of the metadata files may be XML or any other suitable file type. The disposable development and testing environment may expire after a predetermined time period. In some embodiments, the predetermined time period may be three days, seven days, thirty days or any other suitable time period. In other embodiments, the disposable development and testing environment may be terminable—i.e., capable of being terminated. The termination may be actuated by a system user or any other suitable party.

In some embodiments, expiration of the disposable development and testing environment may be implemented using a scheduled system overwrite. In such embodiments, the system may, on a predetermined schedule, overwrite the development and testing environment. The predetermined schedule may be based on the instantiation of the instance of the disposable development and testing environment.

In some embodiments, a developer may create an instance of a development and testing environment in order to develop, improve or enhance a specific code segment. The instance of the development and testing environment may be available to the developer, the developer's team or any other specified groups or individuals. At times, the developer may specify the lifespan of the instance of the development and testing environment. Other times, the lifespan may be system-determined. When the lifespan is system-determined, a developer may request, or order, an override to enable a longer lifespan.

The method may include exporting the plurality of configuration files from the disposable development and testing environment to a local file within the local computing system. The method may include storing a first copy of the plurality of configuration files within the local computing system. The method may include storing a second copy of the plurality of configuration files within the local computing system.

The method may include receiving modifications to the second copy of the plurality of configuration files within the local computing system. The method may include comparing the first copy of the plurality of configuration files with the second copy of the plurality of configuration files. The method may include generating a delta file. The delta file may include the modifications based on the comparing. The method may include uploading the delta file to a source control repository within the cloud computing system.

In some embodiments, the delta file generation may be implemented within the source control repository, or any other suitable repository. In such an embodiment, the original configuration file may be transmitted together with the modified configuration file. The source control repository, or other suitable repository, may compare the original configuration file and the modified configuration file in order to generate a delta file.

The source control repository may store one or more production configuration file(s). The production configuration file(s) may embody the “source is the truth” paradigm. The production configuration file(s) may be pushed to the production environment and function as the configuration file(s) in production. The production configuration file(s) may be modified based on the delta file. The source control repository may store data relating to the modification. Data relating to the modification may include a date and/or timestamp associated with the transmission of the modified configuration file and the identity of the developer that uploaded the modified configuration file.

In some embodiments, a developer may upload one or more modified configuration file(s) to the source control repository. In other embodiments, a developer may upload one or more segments of configuration file modifications to the source control repository. The source control repository may overwrite the production configuration file(s) with the received configuration file(s). The source control repository may overwrite segments of the configuration files that correspond to the received segments of configuration file modifications. In these embodiments, the source control repository may receive and store metadata relating to the received modified configuration file(s) or the segments of configuration file modifications. In this way, the source control repository may identify which developer made which modification at which time.

Identification of which developer made which modification at which time may be useful when a collision is identified—i.e., a first developer made a first change to a first line of code and a second developer made a different change to the first line of code. When a collision occurs, the source control repository may contact both developers and inform them of the collision. The developers may come to a resolution and transmit the resolution to the source control repository. For example, developer A changed an if statement on line 32 to if(condition 23==yes) and developer B changed the if statement on line 32 to if(condition 45==yes). The source control repository may identify this as a collision. The two developers may be alerted, by an alert transmitted from the source control repository. The two developers may conclude that line 32 should be changed to if(condition 23 and condition 45==yes) or if(condition 23 or condition 45==yes). The conclusion may be transmitted by one or more of the developers to the source control repository in response to the collision alert. The source control repository may incorporate the collision resolution to the production configuration file. In some embodiments, the collision resolution may be automated, for example, a collision may automatically defer to the more senior developer.

In some embodiments, different developers may work on different code elements included in the configuration file(s). In these embodiments, each developer may have pulled the configuration file(s) at a different point in time, and may, therefore, be working on a different version of the configuration file(s). In these embodiments, the system may be configured to timestamp the originally retrieved configuration file. The developer may push the modified configuration file(s) together with the timestamp of the originally retrieved configuration file to the source control repository. In this embodiment, the source control repository may maintain copies and timestamps of the different versions of the production configuration files in order to generate an applicable delta file. The delta file can be employed in a manner described above.

The method may include combining the delta file with a plurality of delta files included on the source control repository to create an updated combination configuration file. The method may include pushing the updated combination configuration file from the source control repository to a development repository within the cloud computing system.

The method may include pushing the updated combination configuration file from the development repository to a testing repository within the cloud computing system. The method may also include pushing the updated combination configuration file from the testing repository to a production repository within the cloud computing system.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative flow chart in accordance with principles of the disclosure; and

FIG. 2 shows another illustrative flow chart in accordance with principles of the disclosure.

### DETAILED DESCRIPTION OF THE DISCLOSURE

A system operable to merge a cloud computing environment and a local computing environment. The system may include a cloud computing environment and a local computing environment.

The cloud computing system may include a disposable development and testing environment. The disposable development and testing environment may include a plurality of configuration files. The disposable development and testing environment may include an export function. The export function may export the plurality of configuration files when activated.

The cloud computing system may include a source control repository. The cloud computing system may also include a development repository.

The system may be operable to activate the export function. The export function, when activated, may export the plurality of configuration files to the local computing environment.

The system may store a first copy and a second copy of the plurality of configuration files on the local computing environment. The system may also receive modifications to the second copy of the plurality of configuration files. The system may also compare the first copy of the plurality of configuration files with the second copy of the plurality of configuration files. The system may generate a delta file that includes the modifications based on the comparison.

The system may upload the delta file to the source control repository. The system may combine the delta file with a plurality of delta files in the source control repository to create an updated combination configuration file. The system may push the updated combination configuration file from the source control repository to the development repository within the cloud computing environment.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

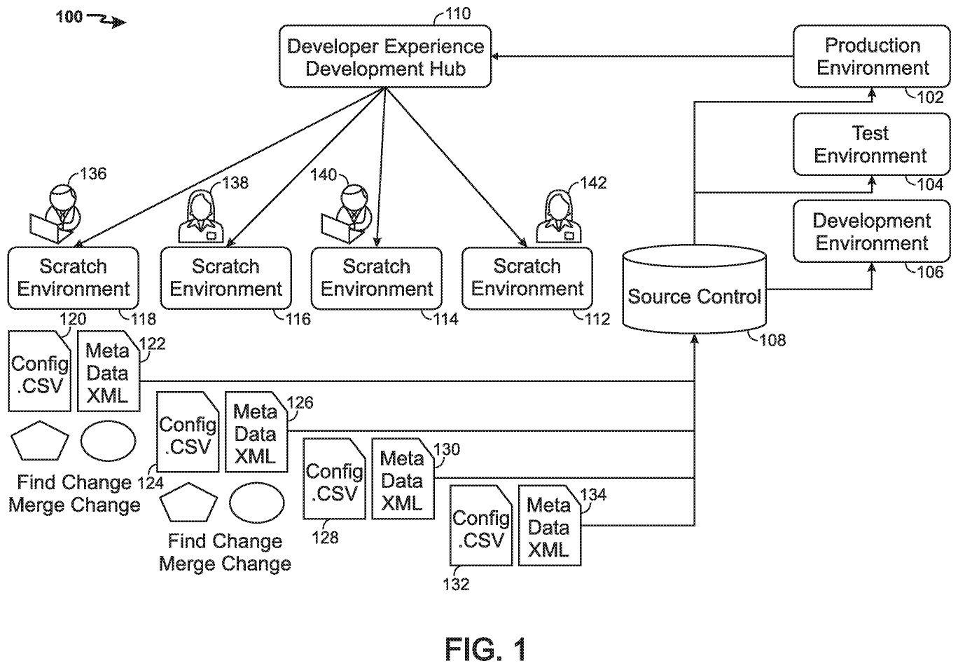

FIG. 1 shows flow diagram 100. Flow diagram 100 may include production environment 102. Production environment 102 may reside on a cloud computing system. Production environment 102 may be the environment from which production code is deployed.

Flow diagram 100 may also include test environment 104. Test environment 104 may reside on the cloud computing system.

Flow diagram 100 may also include development environment 106. Development environment 106 may reside on the cloud computing system.

Production environment 102, test environment 104 and development environment 106 may be associated with source control 108. In some embodiments, source control 108 may reside on the cloud computing system. In other embodiments, source control 108 may reside on a local computing system.

Production environment 102 may be associated with developer experience development hub 110. Developer experience development hub 110 may retrieve, or be provided with, a copy of the production code included in production environment 102. A developer, such as developer 136, 138, 140 or 142, using a scratch environment, such as scratch environment 112, 114, 116 or 118, may pull copies of code segments into a scratch environment from the developer experience development hub 110. Scratch environments may be disposable. Scratch environments may be disposable development and testing environments. A developer may specify for how long a scratch environment may exist. After a predetermined time period, the scratch environment may be voluntarily or involuntarily terminated. Scratch environments may be used to emulate production environments. For example, scratch environments include configuration files, metadata files and other artifacts needed to effectively test-produce an updated version of the code. Scratch environments may enable a developer to write code and/or test code prior to pushing the code to a different environment.

When a user pulls code from developer experience development hub 110 to a scratch environment, the code may be retrieved with one or more artifacts. The artifacts may include a csv (“comma separated value”) configuration file, such as configuration file 120, 124, 128 and 132 and/or a metadata XML file, such as metadata XML file 122, 126, 130 and 134.

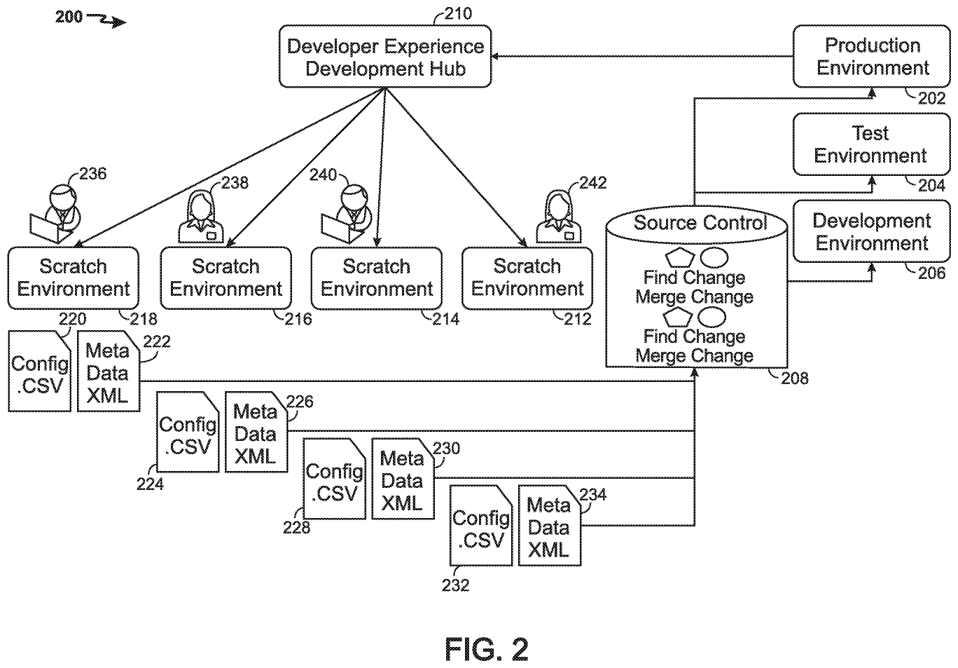

FIG. 2 shows flow diagram 200. Flow diagram 200 may include production environment 202, test environment 204 and development environment 206. Production environment 202, test environment 204 and development environment 206 may be associated with source control 208.

Flow diagram 200 may include developer experience hub 210. Scratch environments 212, 214, 216 and 218 may have been generated by a developer, such as developer 236, 238, 240 and 242. A developer may pull copies of code segments from development hub 210 to a scratch environment together with one or more artifacts, such as configuration csv file 220, metadata XML file 222, configuration csv file 224, metadata XML file 226, configuration csv file 228, metadata XML file 230, configuration csv file 232 and metadata XML file 234.

A developer, such as developer 236, 238, 240 and/or 242 may modify one or more of the artifacts. The modification may be uploaded to source control 208, as described above. In the embodiment shown in flow diagram 200, the delta file may be generated within source control 208.

In some embodiments, a developer may export a copy of the configuration file from a scratch environment (which may or may not be stored in a local environment) to a local development environment. The local development environment may not be disposable. A developer may make changes to the exported configuration files.

A comparison module may compare the original exported configuration file to the modified configuration file. The comparison module may create a delta file. The delta file may contain the differences between the modified configuration file and the original exported configuration file. The delta file may be stamped with metadata, such as a developer identifier, a date and/or time stamp of the export time of the original exported configuration file, a date and/or time stamp of the completion of the modified configuration file, a date and/or time stamp of the creation of the delta file or any other suitable metadata.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for a hybrid cloud computing and local computing system are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for merging a cloud computing system and a local computing system, the method comprising:
creating a disposable development and testing environment within the cloud computing system, said disposable development and testing environment comprising a plurality of configuration files;
exporting the plurality of configuration files from the disposable development and testing environment to a local file within the local computing system;
storing a first copy of the plurality of configuration files within the local computing system;
storing a second copy of the plurality of configuration files within the local computing system;
receiving modifications to the second copy of the plurality of configuration files within the local computing system;
comparing the first copy of the plurality of configuration files with the second copy of the plurality of configuration files;
generating a delta file that includes the modifications based on the comparing;
uploading the delta file to a source control repository within the cloud computing system;
combining the delta file with a plurality of delta files included on the source control repository to create an updated combination configuration file; and
pushing the updated combination configuration file from the source control repository to a development repository within the cloud computing system.

2. The method of claim 1, wherein the method further comprises pushing the updated combination configuration file from the development repository to a testing repository within the cloud computing system.

3. The method of claim 2, wherein the method further comprises pushing the updated combination configuration file from the testing repository to a production repository within the cloud computing system.

4. The method of claim 1, wherein the disposable development and testing environment expires after a predetermined time period.

5. The method of claim 1, wherein the predetermined time period is seven days.

6. The method of claim 1, wherein the disposable development and testing environment is terminable.

7. A system operable to merge a cloud computing environment and a local computing environment, the system comprising:
the cloud computing environment, said cloud computing environment comprising:
a disposable development and testing environment comprising:
a plurality of configuration files; and
an export function, said export function when activated operable to export the plurality of configuration files;
a source control repository; and
a development repository;
the local computing environment;
wherein the system is operable to:
activate the export function to export the plurality of configuration files to the local computing environment;
store a first copy and a second copy of the plurality of configuration files on the local computing environment;
receive modifications to the second copy of the plurality of configuration files;
compare the first copy of the plurality of configuration files with the second copy of the plurality of configuration files;
generate a delta file that includes the modifications based on the comparison;
upload the delta file to the source control repository;
combine the delta file with a plurality of delta files includes in the source control repository to create an updated combination configuration file; and
push the updated combination configuration file from the source control repository to the development repository within the cloud computing environment.

8. The system of claim 7, wherein the system is further operable to push the updated combination configuration file from the development repository to a testing repository within the cloud computing environment.

9. The system of claim 8, wherein the system is further operable to push the updated combination configuration file from the testing repository to a production repository within the cloud computing environment.

10. The system of claim 7, wherein the disposable development and testing environment expires after a predetermined time period.

11. The system of claim 10, wherein the predetermined time period is seven days.

12. The system of claim 7, wherein the disposable development and testing environment is terminable.

13. A hybrid cloud computing and local computing system, the system comprising:
a cloud computing environment, said cloud computing environment comprising:
a source control repository;
a development repository, said development repository being linked to the source control repository;
a production repository, said production repository being linked to the development repository;
a developer experience development repository, said developer experience development repository being linked to the production repository; and
a disposable development and testing environment, said disposable development and testing environment being linked to the developer experience development repository, said disposable development and testing environment comprising:
a plurality of configuration files, said plurality of configuration files being retrieved from the production repository via the developer experience development repository, said plurality of configuration files being pushed to the production repository from the source control repository via the development repository; and
an export function, said export function,
when activated, operable to export the plurality of configuration files; and
a local computing environment;
wherein the system is operable to:
activate the export function to export the plurality of configuration files to the local computing environment;
store the plurality of configuration files within the local computing environment;
receive modified configuration files at the local computing environment;
transmit, from the local computing environment to the source control repository, the modified configuration files;
perform a comparison, at the source control repository, between the modified configuration files and the plurality of configuration files at the source control repository; and
in response to the comparison, update the plurality of configuration files at the source control repository with the modified configuration files.

14. The hybrid cloud computing and local computing system of claim 13, wherein the system is further operable to push the updated configuration files from the source code repository to the development repository.

15. The hybrid cloud computing and local computing system of claim 14, wherein the system is further operable to push the updated configuration files from the development repository to the production repository.

16. The hybrid cloud computing and local computing system of claim 13, wherein the disposable development and testing environment expires after a predetermined time period.

17. The hybrid cloud computing and local computing system of claim 16, wherein the predetermined time period is 72 hours.

18. The hybrid cloud computing and local computing system of claim 13, wherein the disposable development and testing environment is terminable.

19. A hybrid cloud computing and local computing system, the system comprising:
a cloud computing environment, said cloud computing environment comprising:
a source control repository;
a development repository, said development repository being linked to the source control repository;
a production repository, said production repository being linked to the development repository;
a developer experience development repository, said developer experience development repository being linked to the production repository; and
a disposable development and testing environment, said disposable development and testing environment being linked to the developer experience development repository, said disposable development and testing environment comprising:
a plurality of configuration files, said plurality of configuration files being retrieved from the production repository via the developer experience development repository, said plurality of configuration files being pushed to the production repository from the source control repository via the development repository; and
an export function, said export function,
when activated, operable to export the plurality of configuration files; and
a local computing environment;
wherein the system is operable to:
activate the export function to export the plurality of configuration files to the local computing environment;
store the plurality of configuration files within the local computing environment;
receive segments of configuration file modifications at the local computing environment;
transmit, from the local computing environment to the source control repository, the segments of configuration file modifications;
update the plurality of configuration files at the source control repository with the segments of configuration file modifications.

20. The hybrid cloud computing and local computing system of claim 19, wherein the system is further operable to push the updated configuration files from the source code repository to the development repository.
